(19) United States
(12) Patent Application Publication
(10) Pub. No.: US 2023/0286880 A1
(43) Pub. Date: Sep. 14, 2023

(54) METHODS FOR IMPROVING THE COMPATIBILITY OF CROP PROTECTION FORMULATIONS AND TANK MIX APPLICATIONS WITH LIQUID FERTILIZERS

(71) Applicant: SYNGENTA CROP PROTECTION AG, Basel (CH)

(72) Inventors: Eric Stephen OSHIGE, Greensboro, NC (US); Jinsong LEE, Greensboro, NC (US)

(73) Assignee: SYNGENTA CROP PROTECTION AG, Basel (CH)

(21) Appl. No.: 18/040,440

(22) PCT Filed: Aug. 5, 2021
(86) PCT No.: PCT/EP2021/071863

§ 371 Date: Feb. 3, 2023

(30) Foreign Application Priority Data
Aug. 5, 2020 (EP) 20189591.9

(51) Int. Cl. C05G 3/60; C05G 5/27; C05B 15/00

(52) U.S. Cl. CPC C05G 3/60; C05G 5/27; C05B 15/00

(57) ABSTRACT

The present invention relates to methods for improving the compatibility of crop protection formulations and tank mix applications with liquid fertilizers by (i) building a chelating agent into a crop protection formulation, or (ii) adding a chelating agent when mixing the crop protection formulation with the liquid fertilizer.

### TECHNICAL FIELD

The present invention relates to methods for improving the compatibility of crop protection formulations and tank mix applications with liquid fertilizers.

### BACKGROUND

Liquid fertilizers as used herein are any water-based compositions comprising nutrients which enhance the growth of plants. Nutrients are typically distinguished in main macronutrients [nitrogen (leaf growth), phosphorus (development of roots, flowers, seeds, fruit), potassium (strong stem growth, movement of water in plants, promotion of flowering and fruiting], secondary macronutrients [calcium, magnesium and sulfur] and micronutrients [copper, iron, manganese, molybdenum, zinc, boron]. There are many different sort of liquid fertilizers, e.g. liquid fertilizers comprising only the main macronutrients N, P and K [which are typically classified as NP, NK, PK or NPK fertilizers depending on their composition] or only micronutrients or both. The composition of liquid fertilizer may vary widely as they may be targeted on specific crops.

In order to save time, labor and energy, it has become common practice to mix such liquid fertilizers with crop protection formulations in a so-called tank mixing process and then directly applying the mixture onto the crops without addition of any additional water. Crop protection formulations are generally in form of liquid concentrates with relatively high amounts of pesticidal active ingredients, e.g. suspension concentrates (SC) or emulsifiable concentrates (EC), or as solid granules, e.g. water dispersible granules (WG) and water soluble granules (SG). When crop protection formulations are dispersed in liquid fertilizers during the tank mixing process, they tend to flocculate or oil out immediately. Some fertilizer compatibility agents have been developed to be built into crop protection formulations or to add during the tank mixing process. The purpose of these fertilizer compatibility agents is to make crop protection formulation more compatible with liquid fertilizers. The most commonly used fertilizer compatibility agents on the market as post-addition during tank mix application or as built-in agents are phosphate esters and APGs (alkyl polyglucosides). However, these fertilizer compatibility agents have exhibited limited versatility when farmers have choices of not only available a wide variety of liquid fertilizers on the market, but also custom blends of fertilizers or micronutrients for targeted crops. Generally, one fertilizer compatibility agent does not work well with all active ingredients and types of crop protection formulations. Unless a crop protection formulation is specifically formulated to be electrolyte tolerant, the concentrated crop protection formulations will flocculate or oil out immediately when dispersed into a liquid fertilizer.

Hence, there is a strong need for methods to improve the compatibility of crop protection formulations with liquid fertilizers.

### DESCRIPTION OF THE EMBODIMENTS

Crop protection (CP) compositions are generally commercialized either as liquid concentrates with relatively high concentrations of active ingredient(s) or as solid granules. Typical liquid crop protection formulations include but are not limited to:
Suspension concentrate (SC)
Flowable concentrate for seed treatment (FS)
Capsule suspension (CS)
Emulsifiable concentrate (EC)
Microemulsion (ME)
Suspoemulsion (SE)
Dispersible concentrate (DC)
Soluble concentrate (SL).

Typical solid crop protection (CP) compositions include but are limited to:
Water dispersible granules (WG)
Water soluble granules (SG)
Water soluble powder (SP).

It is common practice when applying both liquid or solid CP formulations to disperse the CP compostions directly in the liquid fertilizer without the addition of any additional water. Liquid fertilizers are high electrolyte solutions with high ionic strength. The ionic strength depends on the concentration and the charges of the ions in the liquid fertilizer. Due to this, it is difficult to disperse CP formulations in liquid fertilizers. Generally, CP formulations will flocculate or oil out or show another adverse effect upon dispersion in liquid fertilizers. This is important because such mixtures of CP formulations with liquid fertilizers will be applied as spray mixtures using common spray equipment. For example, flocculation of CP formulations will lead to the blockage of spray nozzles and pipes. This means that in real life CP formulations with such failures cannot be applied commercially directly with liquid fertilizers. This is a significant commercial drawback for such CP formulations. Hence, some compositions have so-called fertilizer compatibility agents built into the compositions (see Background section). However, many of those fertilizer compatibility agents do not have much versatility, i.e. it may work on one particular liquid fertilizer but not on others. Hence, there is a solution to this problem which is more generally applicable when mixing CP formulations with liquid fertilizers before spraying.

It has now been surprisingly found that the building-in of a chelating agent directly into the CP formulation or the addition of a chelating agent during the tank mixing process has a significant beneficial effect on the fertilizer compatibility of a CP formulation. It has been found unexpectedly that the addition of a chelating agent to a CP formulation significantly improves the fertilizer compatibility so that the CP formulation may become compatible for mixing with liquid fertilizers where previously flocculation or sedimentation was observed upon mixing.

Hence, in a first aspect, as embodiment 1, there is provided a method for improving the compatibility of a crop protection formulation with a liquid fertilizer comprising
(i) building a chelating agent into a crop protection formulation, or
(ii) adding a chelating agent when mixing the crop protection formulation with the liquid fertilizer.

In an embodiment 2, there is provided the use of a chelating agent for improving the compatibility of a crop protection formulation with a liquid fertilizer by
(i) building a chelating agent into a crop protection formulation, or
(ii) adding a chelating agent when mixing the crop protection formulation with the liquid fertilizer.

The term “crop protection formulation” as used herein includes both liquid and solid CP formulations. Examples of both are given above. Most common liquid CP formulations are SC and EC and most common solid CP formulations are WG and SG. However, the method according to embodiment 1 may be applied to any typical CP formulation. “Crop protection formulations” usually comprise one or more pesticidally active ingredients including insecticides, fungicides, bactericides, herbicides, acaridcides, nematicides, anthelmintics and plant growth regulators. The method according to embodiment 1 is applicable for any type of pesticidally active ingredient.

The term “chelating agent” as used herein are compounds containing at least two heteroatoms selected from oxygen, nitrogen and sulfur and are capable of entrapping or sequestering one or more metal atom cations. Furthermore, the chelating agents to be used according to the present invention are in the unmetallated form when they are (i) being built into a CP formulation or (ii) added when mixing the CP formulation with the liquid fertilizer.

The term “chelating agent” as used herein are capable of forming acid addition salts and those having at least one acidic group are capable of forming salts with bases. Suitable salts with bases are metal salts, in particular alkali metal salts and alkaline earth metal salts such as sodium, potassium or magnesium salts. Thus, a “chelating agent” as used herein generally comprises a plurality of groups selected from carboxylic acid, hydroxyl, thiol, phosphoric acid and derivatives thereof such as salt derivatives.

Particularly suitable “chelating agents” according to the present invention are selected from aminopolycarboxylic acid chelating agents, aromatic carboxylic chelating agents, aliphatic carboxylic chelating agents, amino acid chelating agents, ether polycarboxylic acid chelating agents, phosphoric acid chelating agents, hydroxycarboxylic acid chelating agents and dimethylglyoxime. The chelating agents may be in the form of the acid or a salt.

Examples of aminopolycarboxylic acid chelating agents include N,N′-ethylene-bis(hydroxyphenyl)glycines (EDDHA), ethylenediaminebis(2-hydroxy-methylphenylacetic acid) (EDDHMA), N,N′-ethylenebis(2-hydroxy-5-sulfophenyl)glycine (EDDHSA), ethylenediaminetetraacetic acid (EDTA), N-(2-hydroxyethyl)-ethylenediaminetetraacetic acid (HEDTA), cyclohexanediaminetetraacetic acid (CDTA), nitriloacetic acid (NTA), iminodiacetic acid (IDA), N-(2-hydroxyethyl)imionodiacetic acid (HIMDA), diethylenetriaminepentaacetic acid (DTPA), glycoletherdiaminetetraacetic acid (GEDTA), ethylenediaminedisuccinic acid (EDDS) and salts thereof.

Examples of aromatic or aliphatic carboxylic acid chelating agents to be used in the present invention include oxalic acid, succinic acid, pyruvic acid, salicylic acid, anthranilic acid, and salts, methyl esters and ethyl esters thereof.

Examples of amino acid chelating agents include glycine, serine, alanine, lysine, cystine, cysteine, ethionine, tyrosine, methionine, and salts and derivatives thereof.

Examples of ether polycarboxylic acid chelating agents include compounds represented by the following formula or similar, and salts (e.g. sodium salt) thereof:

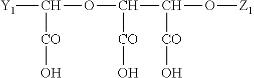

wherein Y₁ represents a hydrogen atom, —CH₂COOH or —COOH, and Z₁ represents a hydrogen atom, —CH₂COOH or —CH₂(—CH₂COOH)COOH.

Examples of hydroxy carboxylic acid chelating agents include malic acid, citric acid, glycolic acid, gluconic acid, heptonic acid, tartaric acid, lactic acid and salts thereof.

Particularly suitable chelating agents to be used in the present invention are aminopolycarboxylic acid chelating agents. Thus, as embodiment 3, there is provided a method for improving the compatibility of a crop protection formulation with liquid fertilizer comprising
(i) building an aminopolycarboxylic acid chelating agent into a crop protection formulation, or
(ii) adding an aminopolycarboxylic acid chelating agent when mixing the crop protection formulation with the liquid fertilizer.

In an embodiment 4, there is provided the use of a chelating agent for improving the compatibility of a crop protection formulation with a liquid fertilizer by
(i) building an aminopolycarboxylic acid chelating agent into a crop protection formulation, or
(ii) adding an aminopolycarboxylic acid chelating agent when mixing the crop protection formulation with the liquid fertilizer.

Particularly, as embodiment 5, there is provided a method for improving the compatibility of a crop protection formulation with liquid fertilizer comprising
(i) building an aminopolycarboxylic acid chelating agent into a crop protection formulation, or
(ii) adding an aminopolycarboxylic acid chelating agent when mixing the crop protection formulation with the liquid fertilizer, wherein
   the aminopolycarboxylic acid chelating agent is selected from N,N′-ethylene-bis(hydroxyphenyl)glycines (EDDHA), ethylenediaminebis(2-hydroxy-methylphenylacetic acid) (EDDHMA), N,N′-ethylenebis(2-hydroxy-5-sulfophenyl)glycine (EDDHSA), ethylenediaminetetraacetic acid (EDTA), N-(2-hydroxyethyl)-ethylenediaminetetraacetic acid (HEDTA), cyclohexanediaminetetraacetic acid (CDTA), nitriloacetic acid (NTA), iminodiacetic acid (IDA), N-(2-hydroxyethyl)imionodiacetic acid (HIMDA), diethylenetriaminepentaacetic acid (DTPA), glycoletherdiaminetetraacetic acid (GEDTA), ethylenediaminedisuccinic acid (EDDS) and salts thereof. More particularly, the aminopolycarboxylic acid chelating agent is selected from N,N′-ethylene-bis(hydroxyphenyl)glycines (EDDHA), ethylenediaminebis(2-hydroxy-methylphenylacetic acid) (EDDHMA), N,N′-ethylenebis(2-hydroxy-5-sulfophenyl)glycine (EDDHSA), ethylenediaminetetraacetic acid (EDTA), N-(2-hydroxyethyl)-ethylenediaminetetraacetic acid (HEDTA) and salts thereof. Even more particularly, the aminopolycarboxylic acid chelating agent is selected from N,N′-ethylene-bis(hydroxyphenyl)glycines (EDDHA), ethylenediaminetetraacetic acid (EDTA) and salts thereof. Most particularly, the aminopolycarboxylic acid chelating agent is ethylenediaminetetraacetic acid (EDTA) or a salt thereof, e.g. sodium salt.

In an embodiment 6, there is provided the use of a chelating agent for improving the compatibility of a crop protection formulation with a liquid fertilizer by
(i) building an aminopolycarboxylic acid chelating agent into a crop protection formulation, or
(ii) adding an aminopolycarboxylic acid chelating agent when mixing the crop protection formulation with the liquid fertilizer, wherein
   the aminopolycarboxylic acid chelating agent is selected from N,N′-ethylene-bis(hydroxyphenyl)glycines (EDDHA), ethylenediaminebis(2-hydroxy-methylphenylacetic acid) (EDDHMA), N,N′-ethylenebis(2-hydroxy-5-sulfophenyl)glycine (EDDHSA), ethylenediaminetetraacetic acid (EDTA), N-(2-hydroxyethyl)-ethylenediaminetetraacetic acid (HEDTA), cyclohexanediaminetetraacetic acid (CDTA), nitriloacetic acid (NTA), iminodiacetic acid (IDA), N-(2-hydroxyethyl)imionodiacetic acid (HIMDA), diethylenetriaminepentaacetic acid (DTPA), glycoletherdiaminetetraacetic acid (GEDTA), ethylenediaminedisuccinic acid (EDDS) and salts thereof. More particularly, the aminopolycarboxylic acid chelating agent is selected from N,N′-ethylene-bis(hydroxyphenyl)glycines (EDDHA), ethylenediaminebis(2-hydroxy-methylphenylacetic acid) (EDDHMA), N,N′-ethylenebis(2-hydroxy-5-sulfophenyl)glycine (EDDHSA), ethylenediaminetetraacetic acid (EDTA), N-(2-hydroxyethyl)-ethylenediaminetetraacetic acid (HEDTA) and salts thereof. Even more particularly, the aminopolycarboxylic acid chelating agent is selected from N,N′-ethylene-bis(hydroxyphenyl)glycines (EDDHA), ethylenediaminetetraacetic acid (EDTA) and salts thereof. Most particularly, the aminopolycarboxylic acid chelating agent is ethylenediaminetetraacetic acid (EDTA) or a salt thereof, e.g. sodium salt.

Particularly, the CP formulation in the method or use according to any one of embodiments 1 to 6 is selected from suspension concentrate (SC), oil in water emulsion (EW), water in oil emulsion (EO), suspoemulsion (SE), soluble liquid (SL), oil dispersion (OD), emulsifiable concentrate (EC), capsule suspension (CS), water dispersible granules (WG) and soluble granules (SG). In one embodiment of the method according to embodiment 1, the CP formulation is selected from suspension concentrate (SC) and emulsifiable concentrate (EC). In another embodiment of the method according to embodiment 1, the CP formulation is a suspension concentrate (SC).

“Building a chelating agent into a crop protection (CP) composition” according to the method or use of any one of embodiments 1 to 6 means that one or more chelating agents are integral parts of the CP formulation, i.e. they form components or co-formulants of the CP formulation. This is the preferred method for improving the fertilizer compatibility of a CP formulation. The amount and type of chelating agent to be built into a CP formulation may vary depending on the type of CP formulation. A person skilled in the art is aware that a chelating agent needs to be soluble in a CP formulation in order to be able to act as a co-formulant. The chelating agent(s) generally have to be in solution in the CP formulation at the time when the CP formulation is dispersed into the liquid fertilizer. A skilled person is aware that the solubility of chelating agents may strongly vary from solvent to solvent and may also be pH dependent in aquous CP formulations, i.e. a chelating agent may not be soluble at low pH but is soluble at high pH. An example for such a chelating agent whose solubility is pH dependent is for example EDTA which tends to form insoluble salts at lower pH. Such insoluble salts of a chelating agent may not only lead to the clogging of application equipment such as spray nozzles but also to a decrease in the ability of a chelating agent to act as a compatibility agent with liquid fertilizers.

As mentioned previously, the amount of chelating agent built into a CP formulation varies according to the specific circumstances. However, if the CP formulation is a SC, then the amount of chelating agent is typically between 1 and 10 weight % of the total CP formulation, particularly between 1 and 7.5 weight %, more particularly between 2 and 5 weight %. Furthermore, if the CP formulation is a SC, then the chelating agent is preferably an aminopolycarboxylic acid chelating agent. Hence, as embodiment 7, there is provided a method according to embodiment 3, wherein the CP formulation is a SC.

The term “fertilizer compatibility agent” as used herein includes any agent which is designed to make agricultural formulations more compatible with liquid fertilizers. Typical fertilizer compatibility agents include but are not limited to alkyl polyglucosides (APGs), phosphate esters, lignosulfonates and graft comb polymers. Preferred fertilizer compatibility agents are APGs and phosphate esters, in particular phosphate esters.

Further fertilizer compatibility agents may of course also be built into the CP formulation. As mentioned previously, typical commercially available fertilizer compatibility agents are phosphate esters and APGs (alkyl polyglucosides). A skilled person understands that the choice of such further fertilizer compatibility agents depends on many factors such as type of CP formulation, active ingredients present and liquid fertilizers to be used. Hence, as embodiment 8, there is provided a method or use according to any one of embodiments 1 to 7, wherein the method or use includes building in a further fertilizer compatibility agent, which is not a chelating agent, into the CP formulation. Particularly, as embodiment 9, there is provided a method or use according to embodiment 8, wherein the further fertilizer compatibility agent is a phosphate ester or an alkyl polyglucosides. More particularly, the further fertilizer compatibility agent is a phosphate ester. A suitable phosphate ester comprises or consists of at least one phosphated C7-C12-alcohol alkoxylate, particularly C9-C11-alcohol alkoxylate, more particularly C7-C12 and C9-C11-branched alcohol alkoxylate, even more particularly phosphated 2-propylheptanol alkoxylate. Preferred phosphate esters are those phosphated 2-propylheptanol alkoxylates which comprise on average 1 to 20 ethoxy units and 0-3 propoxy units and/or butoxy units. More preferably, the phosphate ester is as disclosed in U.S. Pat. No. 8,937,033 B2 (see claims 11-15) and WO2019/162353. More preferably, as embodiment 10, the phosphate ester is selected from

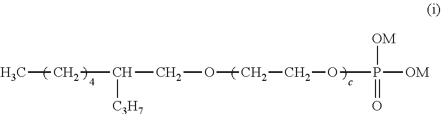

wherein M is selected from H, a monovalent metal ion and R¹R²R³R⁴N⁺, where R¹, R², R³ and R⁴ are selected from H, C1-C4 alkyl and —CH₂CH₂OH, and c is a number 1-20;

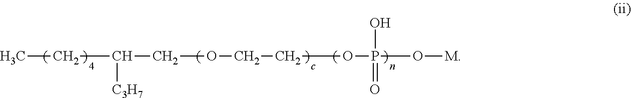

wherein n is a number 1-3, M is selected from H, a monovalent metal ion and R¹R²R³R⁴N⁺, where R¹, R², R³ and R⁴ are selected from H, C1-C4 alkyl and —CH₂CH₂OH, and c is a number 1-20; and
(iii) mixtures of (i) and (ii).

Even more preferably, as embodiment 11, the phosphate ester according to any one of embodiments 4-6 comprises 2 to 4 ethoxy units. Most preferably, as embodiment 12, the phosphate ester according to any one of embodiment 4-7 is a compound of

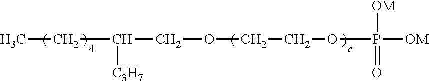

wherein M is selected from H, a monovalent metal ion and R¹R²R³R⁴N⁺, where R¹, R², R³ and R⁴ are selected from H, C1-C4 alkyl and —CH₂CH₂OH, and c is a number 2-4.

Phosphate esters according to any one of embodiments 8 to 12 are commercially available, for example under the tradename Agrilan™. The amount of phosphate ester according to any one of embodiments 8 to 12 built into an agricultural formulation varies according to the specific circumstances. However, if the agricultural formulation is a suspension concentrate (SC), then as embodiment 13, the amount of phosphate ester is typically between 5 and 20 weight % of the total agricultural formulation, particularly between 7.5 and 15 weight %, more particularly between 7.5 and 12.5 weight %.

“Adding a chelating agent when mixing the crop protection formulation with the liquid fertilizer” according to any one of embodiments 1 to 12 means the chelating agent is not an integral component of the CP formulation but is dispersed into the liquid fertilizer at the same time as the CP formulation. It is important that the CP formulation, chelating agent and liquid fertilizer are compatible in such a way that there is no immediate flocculation or sedimentation. A skilled person understands that the CP formulation and chelating agent must be adapted according to common general knowledge in order to avoid such failures. This is also the reason why the method of building in the chelating agent into the CP formulation is preferred as potential failures can be better predicted and controlled. If failures such flocculation and sedimentation can be controlled, then this method also provides improved compatibility with liquid fertilizers.

Furthermore, CP formulations generally comprise also additional co-formulants such as antifoam agents, antifreeze agents, binders, buffers, dispersing agents, wetting agents, dyes, emulsifiers, fillers, pigments, solvents, thickeners. A person skilled in the art is aware that these co-formulants are employed according to the specific circumstances and needs. These co-formulants should not interfere with the function of the chelating agent(s) to improve the compatibility of the CP formulations with liquid fertilizers.

The following Examples serve to illustrate the invention. They do not limit the invention in any way.

### EXPERIMENTAL

### Preparation of SC Formulations According to the Invention

TABLE 1
SC formulation tested.

| Component | w/w (%) |
|---|---|
| Active ingredient (cyclobutrifluram) | 26 |
| Naphthalene sulfonate condensate (wetting | 0-2 |
| agent for cyclobutrifluram) | |
| Antifreeze | 5.0-15.0 |
| Antifoam | 0.01-0.15 |
| Biocide | 0-0.20.0 |
| Phosphate ester | 0.1-30.0 |
| Tristyrylphenol ethoxylate nonionic emulsifier | 0.1-2.0 |
| Sodium Hydroxide, 30% | 1.8 |
| Chelating agent solution (aminopolycarboxylic | 0-35.0 |
| acid chelating agent) | |
| Attapulgite or bentonite clay dispersion | 0.5-8.5 |
| Water | rest |
| TOTAL | 100 |

Formulations were prepared by milling the active ingredient in the presence of water and a wetting agent to the desired particle size. Typical particle sizes of the active ingredients depend on the type of active ingredient, but in general the range of particle sizes is between 1 nm-150 μm, typically between 1 nm-30 μm. To prepare the final suspension concentrate (SC), the milled active ingredient premix was added with stirring to the mixture of remaining components listed in Table 1. Stirring was continued until a homogenous mixture was achieved.

### Liquid Fertilizer Compatibility Testing

The following liquid fertilizers were investigated:

TABLE 2
List of liquid fertilizers investigated.

| ID code | N-P-K Fertilizers + micronutrients |
|---|---|
| A | 10-34-0 |
| B | 0-0-29 with 3 pt Mn per 3 gals |
| C | 0-0-29 with 3 pt Zn per 3 gals |
| D | 10-18-5-1S with 3 pt Zn + 3 pt Mn per 3 gals |
| E | 9-18-9-1s 0.1 Zn |
| F | 8-21-5 |
| G | SOL-U-GRO 12-48-8 |
| H | RISER 7-17-3 |
| I | 8-16-8 2% SULFUR STARTER/TRANSPLANT |
| | SOLUTION |
| J | 4-0-8 |
| K | 7-2-8 |
| L | 0-0-29 with 1 pt Zn + 1 pt Mn per 5 gal |
| M | 8-18-4 0.1Cu 0.2Fe 0.5Mn 0.5 Zn |
| N | 10-18-4 |
| O | 8-24-3-1S GS GREEN 1 pt 9% Zn per 3 gal |

Primary fertilizers comprise NPK (Nitrogen, Phosphorous and Potassium); the number represents the content of each element in the liquid (generally aqueous) fertilizer. For example, 10-34-0 means 10% Nitrogen, 34% Phosphorus (P₂O₅), 0% Potassium (K₂O). Fertilizers A, F, J, K and N in Table 2 are such fertilizers. Fertilizers may also contain secondary nutrients (sulfur, calcium, magnesium) and micronutrients (boron (B), copper (Cu), iron (Fe), manganese (Mn), molybdenum (Mo), zinc (Zn), nickel (Ni) and chloride (Cl)). Some of the fertilizers in Table 2 contain secondary nutrients and micronutrients.

The following method was used to evaluate the tank mix compatibility:

A glass vessel was charged with the liquid fertilizer according to Table 2, followed by addition of the fertilizer-compatible formulation at the typical use rate. The mixture was agitated to simulate mixing in a spray tank and immediately passed through a sieve (50 mesh and 100 mesh). The sieve is given a visual and qualitative rating (either pass=P, marginal=M or fail=F) based on the amount of solid residue on the sieve. The mixture was then tested again after remaining standing for a longer period, for example after standing overnight.

The compatibility ratings were done according to the following categories:
Pass=P: No to minimal residues on the sieve; this was considered as fertilizer compatible.
Marginal=M: moderate residues on the sieve.
Fail=F: significant residues; this was considered as not being fertilizer compatible.

### Technical Effect of the Chelating Agent:

Formulations according to Table 1 were prepared, with the only difference that half the formulations contained 3% of a chelating agent whereas the other half did not contain any chelating agent. All the formulations contained 11% by weight of phosphate ester. The formulations were then tank mixed with the liquid fertilizers according to Table 2 and then assessed as mentioned above. The results are shown in Table 3.

TABLE 3
Results from the fertilizer compatibility testing.

| | Fertilizer ID code | | | | | | | | | | | | | | | |
|---|---|---|---|---|---|---|---|---|---|---|---|---|---|---|---|---|
| | A | | B | | C | | D | | E | | F | | G | | H | |
| Sieve mesh | 50 | 100 | 50 | 100 | 50 | 100 | 50 | 100 | 50 | 100 | 50 | 100 | 50 | 100 | 50 | 100 |
| Without chelating agent | P | M | F | F | F | F | P | P | P | P | P | P | P | P | P | P |
| With chelating agent | P | P | P | P | P | P | P | P | P | P | P | P | P | P | P | P |
| (aminopolycarboxylic | | | | | | | | | | | | | | | | |
| acid chelating agent) | | | | | | | | | | | | | | | | |

| | Fertilizer ID code | | | | | | | | | | | | | |
|---|---|---|---|---|---|---|---|---|---|---|---|---|---|---|
| | I | | J | | K | | L | | M | | N | | O | |
| Sieve mesh | 50 | 100 | 50 | 100 | 50 | 100 | 50 | 100 | 50 | 100 | 50 | 100 | 50 | 100 |
| Without chelating agent | P | P | P | P | P | F | F | F | P | P | P | P | P | P |
| With chelating agent | P | P | P | P | P | P | P | P | P | P | P | P | P | P |
| (aminopolycarboxylic | | | | | | | | | | | | | | |
| acid chelating agent) | | | | | | | | | | | | | | |

Some samples were left standing for periods of time and then reassessed. The results can be found in Table 4.

TABLE 4
Results from the fertilizer compatibility testing after samples
were left standing for 4 and 8 hours, respectively.

| | | 5% Chelating agent | 5% Chelating agent |
|---|---|---|---|
| | No Chelating | (aminopolycarboxylic | (aminopolycarboxylic |
| | agent | acid chelating agent) | acid chelating agent) |
| Fertilizer | 0 hours | 4 hours | 24 hours |
| E | F | P | P |
| F | F | P | P |

Examples of Cyclobutrifluram Formulations with Various Chelating Agent and Phosphate Ester Contents:

The following Examples 1 to 8 of cyclobutrifluram formulations were tested for their compatibility with fertilizer 10-34-0 according to the method mentioned above. The results are shown in Table 4.

TABLE 4
Fertilizer compatibility with fertilizer 10-34-0.

| | Example 1 | Example 2 | Example 3 | Example 4 | Example 5 | Example 7 | Example 8 |
|---|---|---|---|---|---|---|---|
| Components | (% weight) | (% weight) | (% weight) | (% weight) | (% weight) | (% weight) | (% weight) |
| Cyclobutrifluram | 26 | 26 | 26 | 26 | 26 | 26 | 26 |
| Alkylnaphtalene | 1 | 1 | 1 | 1 | 1 | 1 | 1 |
| sulfonate condensate | | | | | | | |
| Tristyrylphenol | 0.7 | 0.7 | 0.7 | 0.7 | 0.7 | 0.7 | 0.7 |
| ethoxylate nonionic | | | | | | | |
| emulsifier | | | | | | | |
| Phosphated 2- | 11 | 11 | 8 | 0 | 11 | 11 | 11 |
| propylheptanol | | | | | | | |
| ethoxylate | | | | | | | |
| Chelating agent | 4 | 4 | 2 | 6 | 3 | 4 | — |
| (aminopolycarboxylic | | | | | | | |
| acid chelating agent) | | | | | | | |
| Propylene Glycol | 15 | 15 | 15 | 15 | 15 | 15 | 15 |
| Non-organic rheology | 7 | 7 | 8 | 8 | 7 | 6.2 | 5.5 |
| modifiers | | | | | | | |
| 10-34-0 Compatibility | Pass | Pass | Pass | Marginal | Pass | Pass | Pass |

Examples of Formulations with Other Active Ingredients:

Commercial formulations were tested for liquid fertilizer compatibility with and without the combination of phosphate ester and chelating agent.

| | Phosphate ester | | | |
|---|---|---|---|---|
| | (phosphated 2- | Chelating agent | | |
| | propylheptanol | (aminopolycarboxylic | Compatibility | |
| | ethoxylate) | acid chelating agent) | 50 | 100 |
| Formulation | (weight %) | (weight %) | mesh | mesh |
| Isocycloseram (200 gram/liter) SC (Syngenta) | 0 | 0 | F | P |
| Isocycloseram (200 gram/liter) SC (Syngenta) | 11 | 3 | P | M |
| Bifenthrin (17.15 weight %; Capture LFR; FMC) | 0 | 0 | P | M |
| Bifenthrin (17.15 weight %; Capture LFR; FMC) | 11 | 3 | P | P |
| 22.20 weight % Imidacloprid and 15.4 weight % | 0 | 0 | F | F |
| Fluopyram (Velum Total; Bayer CropScience) | | | | |
| 22.20 weight % Imidacloprid and 15.4 weight % | 11 | 3 | M | M |
| Fluopyram (Velum Total; Bayer CropScience) | | | | |
| Fluoxastrobin (Tepera Fungicide; Arysta LifeScience) | 0 | 0 | P | P |
| Fluoxastrobin (Tepera Fungicide; Arysta LifeScience) | 11 | 3 | P | P |
| 22.9% (wt %) Azoxystrobin (Quadris; Syngenta) | 0 | 0 | F | M |
| 22.9% (wt %) Azoxystrobin (Quadris; Syngenta) | 11 | 3 | F | P |

1. A method for improving the compatibility of a crop protection formulation with a liquid fertilizer comprising
(i) building a chelating agent into a crop protection formulation, or
(ii) adding a chelating agent when mixing the crop protection formulation with the liquid fertilizer.

2. The method according to claim 1 comprising
(i) building an aminopolycarboxylic acid chelating agent into a crop protection formulation, or
(ii) adding an aminopolycarboxylic acid chelating agent when mixing the crop protection formulation with the liquid fertilizer.

3. The method according to claim 1, wherein
the aminopolycarboxylic acid chelating agent is selected from N,N′-ethylene-bis(hydroxyphenyl)glycines (EDDHA), ethylenediaminebis(2-hydroxy-methylphenylacetic acid) (EDDHMA), N,N′-ethylenebis(2-hydroxy-5-sulfophenyl)glycine (EDDHSA), ethylenediaminetetraacetic acid (EDTA), N-(2-hydroxyethyl)-ethylenediaminetetraacetic acid (HEDTA), cyclohexanediaminetetraacetic acid (CDTA), nitriloacetic acid (NTA), iminodiacetic acid (IDA), N-(2-hydroxyethyl)imionodiacetic acid (HIMDA), diethylenetriaminepentaacetic acid (DTPA), glycoletherdiaminetetraacetic acid (GEDTA), ethylenediaminedisuccinic acid (EDDS) and salts thereof.

4. The method according to claim 1, wherein the formulation is a suspension concentrate.

5. The method according to claim 1, wherein the method includes building in a further fertilizer compatibility agent into the formulation.

6. The method according to claim 1, wherein the fertilizer compatibility agent is a phosphate ester or an alkyl polyglucosides.

7. The method according to claim 1, wherein the fertilizer compatibility agent is a phosphate ester and comprises at least one phosphated 2-propylheptanol alkoxylate.

8. Use of a chelating agent for improving the compatibility of a crop protection formulation with a liquid fertilizer by
(i) building a chelating agent into a crop protection formulation, or
(ii) adding a chelating agent when mixing the crop protection formulation with the liquid fertilizer.

9. The use according to claim 8, wherein
the chelating agent is an aminopolycarboxylic acid.

10. The use according to claim 8, wherein the aminopolycarboxylic acid chelating agent is selected from N,N′-ethylene-bis(hydroxyphenyl)glycines (EDDHA), ethylenediaminebis(2-hydroxy-methylphenylacetic acid) (EDDHMA), N,N′-ethylenebis(2-hydroxy-5-sulfophenyl)glycine (EDDHSA), ethylenediaminetetraacetic acid (EDTA), N-(2-hydroxyethyl)-ethylenediaminetetraacetic acid (HEDTA), cyclohexanediaminetetraacetic acid (CDTA), nitriloacetic acid (NTA), iminodiacetic acid (IDA), N-(2-hydroxyethyl)imionodiacetic acid (HIMDA), diethylenetriaminepentaacetic acid (DTPA), glycoletherdiaminetetraacetic acid (GEDTA), ethylenediaminedisuccinic acid (EDDS) and salts thereof.

11. The use according to claim 8, wherein the formulation is a suspension concentrate.

12. The use according to claim 8, wherein the use includes building in a further fertilizer compatibility agent into the formulation.

13. The use according to claim 12, wherein the fertilizer compatibility agent is a phosphate ester or an alkyl polyglucosides.

14. The use according to claim 8, wherein the fertilizer compatibility agent is a phosphate ester and comprises at least one phosphated 2-propylheptanol alkoxylate.
